(19) United States
(12) Patent Application Publication
(10) Pub. No.: US 2009/0307601 A1
(43) Pub. Date: Dec. 10, 2009

(54) METHOD FOR REFLEXIVE SECURING OF COMPUTER DISPLAYS

(75) Inventors: David Bruce Kumhyr, Austin, TX (US); Lydia Mai Do, Research Triangle Park, NC (US); Pamela Ann Nesbitt, Tampa, FL (US)

Correspondence Address: Locke Lord Bissell & Liddell LLP;Attn: IP Docketing, Three World Financial Center, New York, NY, 10281-2101, US

(73) Assignee: IBM Corporation, Armonk, NY (US)

(21) Appl. No.: 12/133,826

(22) Filed: Jun. 5, 2008

(51) Int. Cl. G06F 3/00

(52) U.S. Cl. 715/741

(57) ABSTRACT

A system for preventing unauthorized viewing of content displayed on a computer display is presented. Once the system is activated, a computer user's eyes are tracked. If some source of interruption enters the vicinity of the user, the computer user will reflexively glance or look at the distraction, which accordingly results in the user removing his focus from the content on the computer display. As the user's focus is diverted from the display due to the interruption, the eye tracking detects this. In response to the detected removal of focus, the computer display is locked out extremely rapidly such that the content is no longer displayed.

### FIELD OF THE DISCLOSURE

The disclosure relates to a method for preventing unauthorized viewing of information on computer screens.

### BACKGROUND

Whether operating a computer in a high security environment or viewing sensitive information in a public setting, there exists the risk that an unauthorized party may accidentally or deliberately view the data displayed on a computer screen. Consequently there is a need to be able to shield a computer display from these attempts to view it.

Normal methods of obscuring the information, such as covering the information with another application window, minimizing the information window or shutting down the display, require an overt action on the computer user's part, which the user may not choose to perform. An additional associated drawback to these methods is that they are not instantaneous. As they require the user to manipulate the computer, some time must elapse before the displayed information is concealed. The user's reaction time may simply not be quick enough to prevent viewing of the information under consideration. The user's ability to react may be further negatively affected by various factors such as distractions, intense focus or conversation.

Physical failsafe switches, such as the “dead man's” switches found in railroad locomotives, are used to automatically shut down machinery when a human operator becomes incapacitated. Although a failsafe like a dead man's switch, configured to turn off a computer display when the user departs, could achieve this security goal, it is not realistic. It is not feasible to have computer users continually hold down a spring loaded switch during the entire time they are working. Furthermore, a user may scheme to circumvent these types of physical failsafes since they are onerous.

Accordingly, what is needed is a solution to control whether or not information is displayed on the computer that is conceptually similar to a “deadman's switch” yet requires little overt action on the part of the user.

### SUMMARY

The present disclosure relates to a security method for preventing unauthorized viewing of information on computer screens, based upon reflexive actions of the computer's user. Specifically, such a security method may be achieved by tracking the reflexive movements of the user's eyes. Upon activation of the system, the camera tracks the computer user's eyes. So long as the eyes are focused on the computer display, the computer display operates normally.

If some source of interruption enters the vicinity of the user, the computer user will reflexively glance or look at the distraction, which accordingly results in the user removing his focus from the content on the computer display. The camera system detects when the user's eyes focus on the source of interruption. Immediately thereafter, the system locks out the computer display such that the content is no longer displayed. The advantages inherent to this method include instantaneous protection of displayed information coupled with almost no burden on the computer user.

In accordance with at least one disclosed example, a method for reflexively securing a computer display comprises: activating the system; tracking the computer's user's eyes; determining when said eyes focus on a source of interruption such that said focus is removed from the content displayed on the computer display; and in response to said removal of focus, locking-out the computer display such that the content is no longer displayed, wherein said activating step is selected from the group consisting of: the computer's user loses focus on the computer for a predetermined period of time, the computer's user looks at a specific predetermined area of the display, the computer's user generates input through the computer's peripherals, the computer's user comes into proximity to the computer, and the computer's user continuously exerts force on a physical switch.

### BRIEF DESCRIPTION OF THE SEVERAL VIEWS OF THE DRAWINGS

FIG. 1 is a flow diagram of an example embodiment for the sequence of steps that trigger the security method.

### DETAILED DESCRIPTION

The disclosure is directed to a security method which obscures information displayed on a computer screen nearly instantly, because the lock out of the display is triggered by reflexive eye movement of the user.

The system comprises a computer and associated peripherals, a display screen, a camera system and motion tracking software. The camera and motion tracking software is used for determining the direction of gaze based on video imagery of human eye. Any known software can be used for the purpose of tracking the eye movement based on the video signal, including for example, what is disclosed in: Ashit Talukder, John-Michael Morookian, S. Monacos, R. Lam, C. Lebaw & A. Bond, Real-Time Non-Invasive Eyetracking And Gaze-Point Determination For Human-Computer Interaction And Biomedicine, SPIE Defense and Security Symposium, Optical Patter Recognition XV, Jet Propulsion Laboratory, National Aeronautics and Space Administration (2004).

When a user looks away from the screen, such as when an unauthorized individual enters the room where the user and computer are located, the system detects the user's eye movement and locks out the screen.

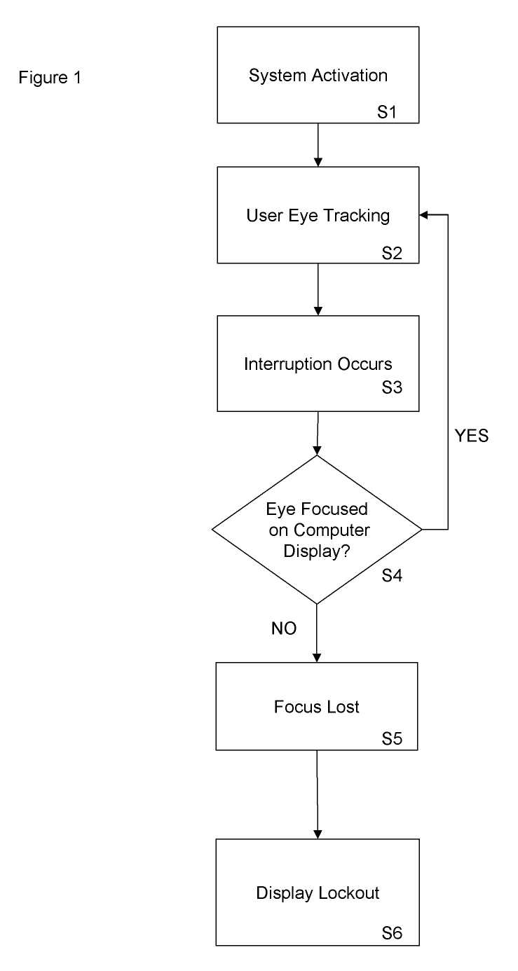

FIG. 1 illustrates a flowchart which describes the operation of the reflexive security method. Although the security method is based upon tracking movement of the computer user's eyes, the first step in the method is activation (Si) of the security system. As explained more fully below there may be many possible criteria for activating the security system.

Once the security system is activated, the computer user's eye movements are tracked (S2) while he is utilizing the computer. The tracking system is primarily concerned with whether the user's eyes are focused on the computer display.

When an interruption (S3) does occur in the user's workspace, the user may react to it reflexively by looking at it. The eye tracking system detects any eye motion resulting from interruption (S3) that causes the user to look away from the computer display. It is presumed that such an interruption may represent a security threat. Automatically responding to the user's loss of focus (S5), the security system locks out the computer display (S6) such that any information visible on the display immediately before the interruption is now concealed. As the user's eye movement in response to the interruption is reflexive, and the subsequent display lockout is automatically triggered by detection of the eye movement, the display lockout is extremely rapid.

This security measure requires no overt special effort and reflexively manages security for the user. Thus if, for example, the source of interruption is an individual seeking to read the display contents, the security method can be effective in quickly preventing any eavesdropping. Should the interruption not warrant the user's attention, however, and his gaze does not depart the computer screen, normal eye tracking is resumed (S2).

This method, however, may become irritating to the computer user if it were to disable the screen every time the user looked away. For example, there may be legitimate reasons why a user's eyes may be drawn off of the computer screen (e.g., reading a paper document or working on a problem with a coworker). In a situation where the user's eyes must regularly alternate between the computer display and an off-display reference, the activated security method would result in the display constantly becoming locked, which would require the user to unlock the display. This could mean that the user would have to enter a password to unlock the display, as is implemented in many computer operating systems.

Therefore, in one embodiment, activation (S1) of the reflexive display lockout security method may be configured based on certain conditions or events, including for example the following scenarios. One condition is a time delay. Using the time delay, activation of the system only occurs after the user has lacked focus on the computer display for a predetermined amount of time, perhaps several seconds. This takes into consideration that a user may need to split attention between onscreen and offscreen work items. Another condition or activation event is a location trigger. Using the location trigger, activation of the system occurs when the user looks at a predetermined area of the screen to denote activation of lockout. This allows the user to affirmatively choose whether to activate the security method. Similarly, activation could occur when some denoted area(s) of the computer switch on the lockout method based on sensors or peripherals (i.e. keypad, touchpad, mouse, etc.). In other words, the system is active when the user generates input through the computer peripherals or perhaps enters a password. Yet another condition may be a user proximity trigger. Using the user proximity trigger, activation may be based on the computer user's physical proximity to the computer. This may be implemented by monitoring the video imagery or with a proximity sensor. Finally, activation of the system may be achieved when the user applies force to a foot pedal or other physical device much like “dead man's switch.”

It will be appreciated by persons skilled in the art that the present disclosure is not limited to what has been particularly shown and described hereinabove. Rather, the scope of the present disclosure is defined by the claims which follow. It should further be understood that the above description is only representative of illustrative examples of embodiments. For the reader's convenience, the above description has focused on a representative sample of possible embodiments, a sample that teaches the principles of the present disclosure. Other embodiments may result from a different combination of portions of different embodiments.

The description has not attempted to exhaustively enumerate all possible variations. The alternate embodiments may not have been presented for a specific portion of the disclosure, and may result from a different combination of described portions, or that other undescribed alternate embodiments may be available for a portion, is not to be considered a disclaimer of those alternate embodiments. It will be appreciated that many of those undescribed embodiments are within the literal scope of the following claims, and others are equivalent.

What is claimed is:

1. A method for operating a system for preventing unauthorized viewing of content displayed on a computer display, the method comprising:
activating the system;
tracking the computer's user's eyes;
determining when said eyes focus on a source of interruption such that said focus is removed from the content displayed on the computer display; and
in response to said removal of focus, locking-out the computer display such that the content is no longer displayed,
wherein said activating step is selected from the group consisting of:
the computer's user loses focus on the computer for a predetermined period of time,
the computer's user looks at a specific predetermined area of the display,
the computer's user generates input through the computer's peripherals,
the computer's user comes into proximity to the computer, and
the computer's user continuously exerts force on a physical switch.
